(19) United States
(12) Patent Application Publication
(10) Pub. No.: US 2015/0099306 A1
(43) Pub. Date: Apr. 9, 2015

(54) TEST CASSETTE READING DEVICE AND READING METHOD THEREOF

(71) Applicant: HUI-CHI KU, Kaohsiung City (TW)

(72) Inventor: HUI-CHI KU, Kaohsiung City (TW)

(21) Appl. No.: 14/246,652

(22) Filed: Apr. 7, 2014

(30) Foreign Application Priority Data
Oct. 8, 2013 (TW) 102136320

(51) Int. Cl. G01N 35/00

(52) U.S. Cl. CPC G01N 35/00732; G01N 35/00871; G01N 35/00029; G01N 2035/00752; G01N 2035/00891; G01N 2035/00108
USPC 436/87; 422/403; 436/169; 436/111

(57) ABSTRACT

A reading device for reading and analyzing a test cassette having an identification code includes a reading unit, used for reading the identification code marked by the test cassette and carrying out interpretation on a plurality of test lines of the test cassette; an operating unit, used for operating the reading device; a processing unit, used for interpreting a test result with the identification code and the test lines; and a display unit, used for displaying the test result of the test cassette.

### CROSS-REFERENCE TO RELATED APPLICATION

This application claims the benefit of Taiwan Patent Application No. 102136320, filed on Oct. 8, 2013, which is hereby incorporated by reference for all purposes as if fully set forth herein.

### BACKGROUND

1. Field of the Invention

The present invention relates to a test cassette reading device in that interpretation of a test result is carried out by reading an identification code of a test cassette.

2. Related Art

Most of the rapid test cassettes on the current market are designed qualitatively, and the interpretation manner is mainly from visual observation with referring to instruction manual for a test result. Such test manner is general, increases lots of personal errors of interpretation and is apt to cause confusion in test items, which is a rough and precision insufficiency testing way. Other than that, for the reasons that an analyzer specifically for testing is commonly confined in analyzing one test item, each test item consuming a specific analyzer will take up much space, and the size of the analyzers may not be easy to carry, with a certain degree of complexity in operation, and the necessity to spend time reading instruction manual to get familiar with the operation manner for ordinary users, the prevalence thereof is consequently decreased.

In addition, generally after a test result is obtained from a test cassette, it is required for users to classify and record the test result on their own, and upon encountering heavy load of tests to be processed, much time will be taken in classification and results recording. Owing to that currently portable 3C products and portable interpretation apparatuses are manufactured more sophisticatedly, the combination of portable 3C products and interpretation apparatuses with rapid test cassettes for a quantitative and rapid test result has become a main trend on today's rapid tests market.

### SUMMARY

To solve the forgoing deficiencies, the present invention supplies a reading device for reading and analyzing a test cassette having an identification code, the reading device including a reading unit, used for reading the identification code marked by the test cassette and carrying out interpretation on a plurality of test lines of the test cassette; an operating unit, used for operating the reading device; a processing unit, interpreting a test result using the identification code and the test lines; and a display unit, used for displaying the test result of the test cassette.

The present invention further supplies a reading device for shooting and analyzing a test cassette having an identification code, including a shooting unit, used for shooting the identification code marked by the test cassette and a plurality of test lines of the test cassette; an operating unit, used for operating the reading device; a processing unit, interpreting a test result using the identification code and the test lines; and a communication unit.

The present invention further supplies a reading method for a test cassette having an identification code, applied to a reading device, including operating the reading device by an operating unit; reading the identification code marked by the test cassette and a plurality of test lines of the test cassette by a reading unit; interpreting a test result on the test lines using the identification code by a processing unit; and displaying the test result on a display unit.

The present invention may be applied to test-specific devices or portable electronic products, and thereby a single reading device may be used for carrying out interpretation on test cassettes for different test items, not only eliminating the need to manufacture specific reading devices in view of different test items, increasing the wide utilization of reading devices but also avoiding the misjudgment caused by visual observation applied in test cassettes interpretation, and achieving the increase of precision in testing. Current smart mobile phones almost are equipped with the components required for the present invention, in combination of the interpretation software researched and developed from the present invention, thereby overcoming the problem of uneasiness in carrying the large size analyzers, also achieving the purpose of simple in use and for anytime, anywhere, and therefore providing referenced data and results in aiding diagnoses of diseases.

### BRIEF DESCRIPTION OF THE DRAWINGS

FIG. 1 is a diagram illustrating an embodiment of a reading device according to the present invention;

FIG. 2 is a diagram of a test cassette inserted into the reading device of FIG. 1;

FIG. 3 is a diagram illustrating another embodiment of a reading device according to the present invention;

FIG. 4 is a diagram of another angle of FIG. 3;

FIG. 5 depicts a block diagram of components of a reading device according to the present invention.

### DETAILED DESCRIPTION

The present invention is described in embodiments with reference to the annexed drawings.

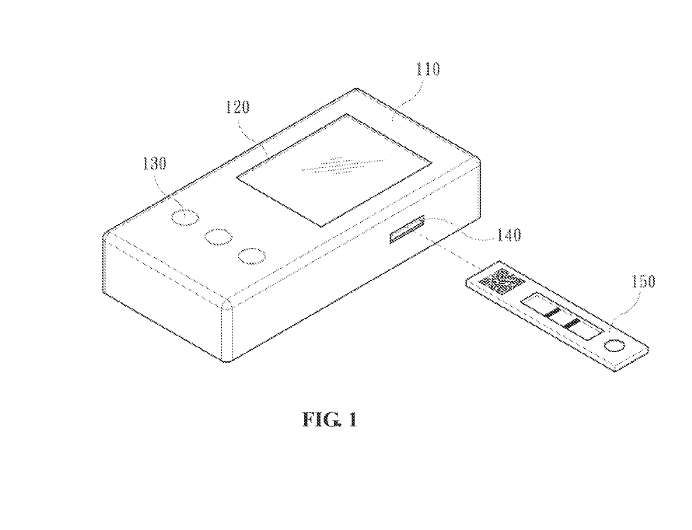

Please refer to FIG. 1, a diagram illustrating embodiment of a reading device 110 of the present invention, which comprises a reading device 110, a screen 120, a button 130 and a slot 140.

A surface of the reading device 110 includes the screen 120 and the button 130 with another surface of the reading device 110 including the slot 140 shaped like a trough.

The screen 120 is used for displaying a testing status of the reading device 110, comprising a frame, a test standard value, a test result, and so on of a test cassette 1511 The button 130 is used for controlling operation of the reading device 110. The slot 140 is used for accommodating the test cassette 150.

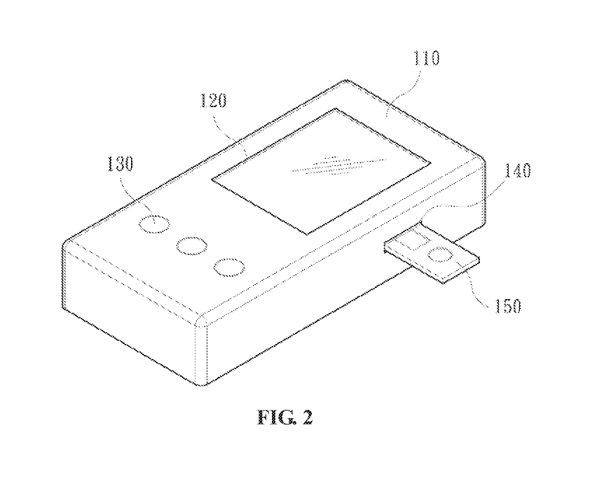

After inserting a test cassette 150 into the slot 140, as shown in FIG. 2, by the button 130, the reading device 110 is operated to commence reading an identification code and a set of test lines of the test cassette 150, wherein the reading device may further include an optical component, such as a camera lens or a CCD (Charge-coupled Device, capable of sensing light rays and converting images into digital signals), used for shooting or sensing the identification code and the test lines of the test cassette 150.

The identification code of the test cassette 150 may be types of readable barcodes such as a one-dimensional bar code or a two-dimensional barcode, like a QR Code (Quick Response Code, a type of two-dimensional bar codes) or a Chinese-sensible code, including a test item and a test standard value of the test cassette 150, wherein the test standard value may be a data, a data scope or a data database and so forth. For example, the test item is a beta agonists, or a human chorionic gonadotropin, etc., and the test standard value is 0 bbp and so forth.

Further a processing unit of the reading device 110 is used for comparing the test standard value with the test lines of the test cassette 150, thereby interpreting the test result of the test cassette 150 and displaying the test result on the screen 120, wherein the processing unit may be a central processing unit (CPU) and so forth.

Moreover, the reading device 110 may further comprise a speech unit, giving a prompt in operation, and a storage unit, used for storing a test result, wherein the speech unit may be a buzzer and the storage unit may be a memory card and so forth.

According to another embodiment illustrating the present invention, a mobile phone having a camera function is used for a reading device of a test cassette, which includes a mobile phone 300, a camera lens 310 and a test cassette 400. The test cassette 400 further includes an identification code 410, a reaction region 420 and a specimen collection region 430.

The identification code 410 of the test cassette 400 may be types of readable barcodes such as a one-dimensional bar code or a two-dimensional barcode, like a QR Code (Quick Response Code, a type of two-dimensional bar codes) or a Chinese-sensible code, including a test item and a test standard value of the test cassette 400, wherein the test standard value may be a data, a data scope or a data database and so on. For example, the test item is a beta agonists, or a human chorionic gonadotropin, etc., and the test standard value is 0 bbp and so forth. The specimen collection region 430 of the test cassette 400 is used for collecting a specimen and penetrating through the reaction region 420 for carrying out a reaction.

After the test cassette 400 finishes collecting the certain amount of a specimen and completing the reaction in the reaction region 420, the identification code 410 of the test cassette 400 and the reaction region 420 is located within the field of view of the camera lens 310 to enable the mobile phone 300 to identify the identification code 410 for obtaining a test item and a test standard value of the test cassette 400 and then to carry out interpretation on the test result of the reaction region 420 with the test standard value of the test cassette 400.

After the mobile phone 300 obtains the test result, such result may be further stored in a storage unit, such as a memory card or via a communication unit like wireless network or bluetooth, the test result may be transmitted to another device for sharing.

Moreover, the mobile phone 300 may further include a testing application for interpreting, sorting, recording and transmitting of the test cassette 400, making further preservation and utilization of the test result.

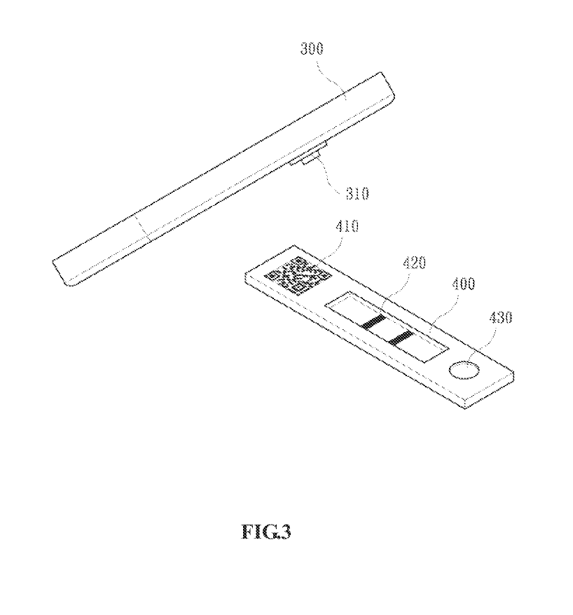

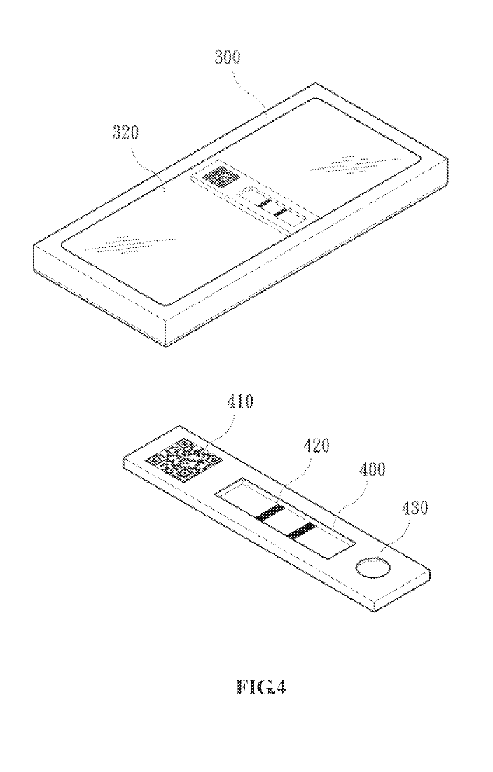

FIG. 4 is a diagram of another angle of the embodiment of FIG. 3, wherein the identification code 410 of the test cassette 400 and the reaction region 420 are located within the field of view of the camera lens 310 to enable a screen 320 of the mobile phone 300 to display the frames of the identification code 410 and the reaction region 420 for operating interpretation afterwards.

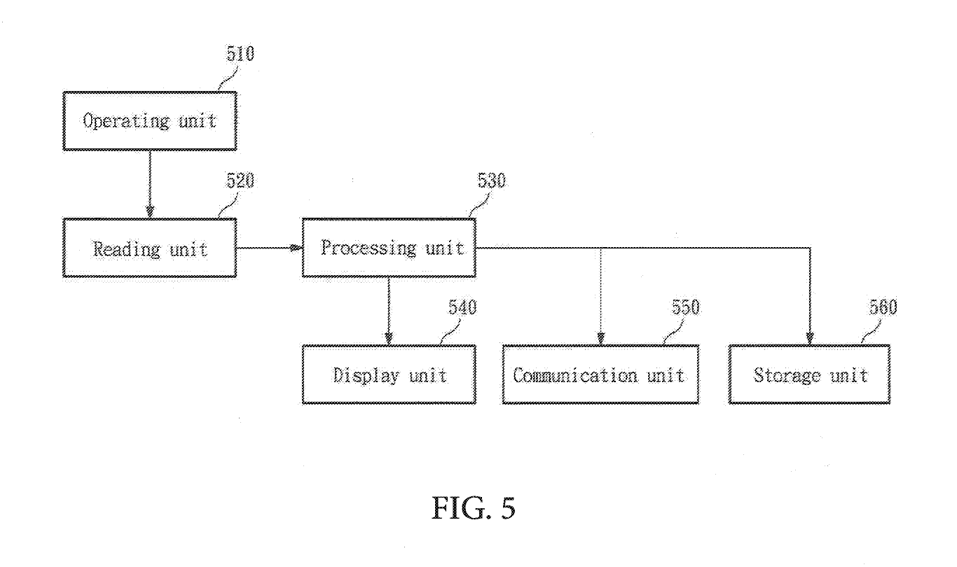

FIG. 5 depicts a block diagram of components of a reading device according to the present invention, including an operating unit 510, a reading unit 520, a processing unit 530, a display unit 540, a communication unit 550 and a storage unit 560.

The operating unit 510 is used for sending an operation message to the reading unit 520 for reading, wherein the operating unit 510 may be a tangible button, an application, et cetera and the reading unit 520 may be an optical component having a shooting function, like a camera lens, etc. to shoot a picture of an object to be read.

The shooted material image of reading unit 520 will be transmitted to the processing unit 530 for analyzing, wherein the processing unit 530 may be a calculation element, like a CPU and so forth.

The processing unit 530 displays the result of analysis on the screen of the display unit 540 or transmits the result of analysis by the communication unit 550 to another device for sharing or directly stores the result of analysis in the storage unit 560, wherein the storage unit 560 may be a memory card and so forth.

The present invention is described illustratively in the foregoing embodiments, and it's not desired to limit the scope of the invention. Accordingly, it should be noted that for those of ordinary skill in the art, without departing from the spirit and scope of the present invention, all suitable modifications and equivalents may be resorted to, falling within the scope of the invention.

What is claimed is:

1. A reading device for reading and analyzing a test cassette having an identification code, including:
a reading unit, used for reading the identification code marked by the test cassette and a plurality of test lines of the test cassette;
an operating unit, used for operating the reading device;
a processing unit, interpreting a test result using the identification code and the test lines; and
a display unit, used for displaying the test result of the test cassette.

2. The reading device of claim 1, wherein the reading unit is an optical component, used for identifying a test material of the identification code and detecting color presence of the test lines, the test material including a test item and a test standard value.

3. The reading device of claim 1, further including a speech unit used for giving a prompt in operation.

4. The reading device of claim 1, further including a storage unit used for storing the test result.

5. A reading device for shooting and analyzing a test cassette having an identification code, including:
a shooting unit, used for shooting the identification code marked by the test cassette and a plurality of test lines of the test cassette;
an operating unit, used for operating the reading device;
a processing unit, interpreting a test result using the identification code and the test lines;
a display unit, used for displaying the test result of the test cassette; and
a communication unit.

6. The reading device of claim 5, wherein the shooting unit is an optical component, used for shooting the identification code to obtain a test material and detecting color presence of the test lines, the test material including a test item and a test standard value.

7. The reading device of claim 5, further including a speech unit used for giving a prompt in operation.

8. The reading device of claim 5, further including a storage unit used for storing the test result.

9. A reading method of a test cassette having an identification code for a reading device, including:
operating the reading device by an operating unit;
reading the identification code marked on the test cassette and a plurality of test lines of the test cassette by a reading unit ;
interpreting a test result using the identification code on the test lines by a processing unit; and
displaying the test result on a display unit.

10. The reading method of claim 9, wherein the reading unit is an optical component, used for identifying the identification code to obtain a test material and detecting color presence of the test lines, the test material including a test item and a test standard value.

11. The reading method of claim 9, further including giving a prompt in operation by a speech unit.

12. The reading method of claim 9, further including transmitting the test result to another device by a communication unit.

13. The reading method of claim 9, further including storing the test result by a storage unit.
